(19) United States
(12) Patent Application Publication
(10) Pub. No.: US 2026/0025026 A1
(43) Pub. Date: Jan. 22, 2026

(54) POWER SUPPLY SYSTEM BY OPTICAL FIBER

(71) Applicant: Commissariat à l'Energie Atomique et aux Energies Alternatives, Paris (FR)

(72) Inventors: Christophe PRAT, Grenoble (FR); Esteban CABANILLAS, Grenoble (FR)

(21) Appl. No.: 19/266,940

(22) Filed: Jul. 11, 2025

(30) Foreign Application Priority Data
Jul. 16, 2024 (FR) 2407783

(51) Int. Cl. H02J 50/30; H02J 50/00; H02J 50/80; H04B 10/80

(52) U.S. Cl. CPC H02J 50/30; H02J 50/005; H02J 50/80; H04B 10/807

(57) ABSTRACT

The present description concerns a system (100) comprising first (101) and second (103) electronic devices coupled by an optical fiber (105), wherein: the first device comprises a laser source (107) intended to illuminate the optical fiber; the second device comprises a photoelectric converter (111) intended to be illuminated from the optical fiber and a capacitive element (115) for storing electrical energy generated by the photoelectric converter; and the first and second electronic devices comprise a control circuit connected to the capacitive element and configured to: acquire a first charge curve of the capacitive element; compare the first charge curve with a second reference charge curve; and in case of a difference between the first and second charge curves, adapt an optical power of the laser source.

### FIELD

The present disclosure generally concerns electronic devices, more particularly fiber optic power supply systems.

### BACKGROUND

Fiber optic power supply systems have been provided. These systems typically comprise first and second electronic devices coupled together by an optical fiber. The first device generally comprises a source of light radiation, for example a high-power laser source, intended to inject into the optical fiber an optical signal for powering the second device. Further, the second device generally comprises a photoelectric converter, for example, a photodiode, intended to convert into electrical energy the optical power supply signal emitted by the first device and transmitted by the optical fiber. The electrical energy generated by the photoelectric converter is stored, for example, in a capacitive element, for example a capacitor, of the second device. The second device can also use the optical fiber to send data to the first device. In this case, the second device comprises, for example, a laser source enabling to emit, to the first device, an optical data signal transmitted by the optical fiber.

U.S. Pat. No. 7,965,948 describes an example of such a fiber optic power supply system.

However, existing fiber optic power supply systems have various disadvantages. In particular, optical phenomena occurring in the optical fiber and/or electro-optical phenomena occurring in the photoelectric converter may cause a drop in efficiency, or even a partial or total degradation or destruction, of the fiber optic power supply system.

To overcome this problem, US patent application US 2002/0131757 provides modulating the power of the laser source of the first device according to a level of an optical signal sampled from the optical fiber coupling the first and second devices, the optical fiber then having a structure specifically adapted to the implementation of such a sampling. The optical signal thus sampled from the optical fiber provided for this purpose is more particularly processed by a control circuit enabling, by means of continuously-adjustable filters, to modify the power of the laser radiation injected into the optical fiber.

Other existing fiber optic power supply systems use rotary or thermo-optical filters in order to modulate the optical power of the laser source. However, rotary filters only enable to modify the optical power in discrete, that is, non-continuous, manner, while thermo-optical filters suffer from problems of slow operation.

Further, another approach consists in providing a plurality of optical fibers to couple the first and second devices of a fiber optic power supply system, the second device then comprising a plurality of photoelectric converters respectively illuminated by the optical fibers. This has the advantage of distributing, over a plurality of optical fibers and a plurality of photoelectric converters, the optical power emitted by the laser source of the first device. However, this causes an increase in the complexity and cost of the system.

### SUMMARY

There exists a need to overcome all or part of the disadvantages of existing fiber optic power supply systems. It would in particular be desirable to be able to modulate the optical power of the laser source for powering the first device without complicating the system, in particular without resorting to optical samplings or to the use of filters.

For this purpose, an embodiment provides a system comprising first and second electronic devices coupled by an optical fiber, wherein:
the first electronic device comprises a laser source intended to illuminate a first end of the optical fiber;
the second electronic device comprises a photoelectric converter intended to be illuminated from a second end of the optical fiber opposite to the first end, and a capacitive element for storing electrical energy generated by the photoelectric converter; and
the first and second electronic devices comprise a control circuit connected to the capacitive element and configured to implement the following successive steps:
   a) acquiring a first charge curve of the capacitive element;
   b) comparing the first charge curve with a second reference charge curve; and
   c) in case of a difference between the first and second charge curves, adapting an optical power of the laser source.

According to an embodiment, step b) is implemented by a first control chip of the first electronic device.

According to an embodiment, step b) is implemented by a second control chip of the second electronic device.

According to an embodiment, the second electronic device further comprises a variable resistive component associated in parallel with the photoelectric converter, the control system being further configured to implement the following successive steps:
d) determining a first resistance value of the variable resistive component for which the photoelectric converter has an optimum conversion efficiency;
e) comparing the first resistance value with a second reference resistance value; and
f) in case of a difference between the first and second resistance values, adapting the optical power of the laser source.

According to an embodiment, step e) is implemented by the first control chip.

According to an embodiment, step e) is implemented by the second control chip.

According to an embodiment, the conversion efficiency is estimated by a measurement of a photocurrent supplied by the photoelectric converter.

According to an embodiment, the adaptation of the power of the laser source is a decrease in the power of the laser source.

According to an embodiment, the capacitive element is a capacitor comprising two conductive plates separated by an insulating region.

According to an embodiment, the first and second devices are coupled by the optical fiber only.

An embodiment provides a method of controlling a system comprising first and second electronic devices coupled by an optical fiber, wherein:
the first electronic device comprises a laser source intended to illuminate a first end of the optical fiber;
the second electronic device comprises a photoelectric converter intended to be illuminated from a second end of the optical fiber opposite to the first end, and a capacitive element for storing electrical energy generated by the photoelectric converter; and
the first and second electronic devices comprise a control circuit connected to the capacitive element,
   the method comprising the following successive steps, implemented by the control circuit:
a) acquiring a first charge curve of the capacitive element;
b) comparing the first charge curve with a second reference charge curve; and
c) in case of a difference between the first and second charge curves, adapting an optical power of the laser source.

According to an embodiment, the method further comprises the following successive steps, implemented by the control circuit:
d) determining a first resistance value of a variable resistive component of the second electronic device, associated in parallel with the photoelectric converter, for which the photoelectric converter has an optimum conversion efficiency;
e) comparing the first resistance value with a second reference resistance value; and
f) in case of a difference between the first and second resistance values, adapting the optical power of the laser source.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 schematically and partially illustrates, in the form of blocks, an example of a fiber optic power supply system;

FIG. 2 is a graph illustrating simplified examples of charge curves of a capacitive element of the fiber optic power supply system of FIG. 1;

FIG. 3 is a graph illustrating an example of a curve of variation of a conversion efficiency of a photoelectric converter of the fiber optic power supply system of FIG. 1; and

FIG. 4 is a graph illustrating an example of a curve of variation of a resistance of a resistive element associated in parallel with the photoelectric converter of the fiber optic power supply system of FIG. 1.

### DETAILED DESCRIPTION OF THE PRESENT EMBODIMENTS

Like features have been designated by like references in the various figures. In particular, the structural and/or functional features that are common among the various embodiments may have the same references and may dispose identical structural, dimensional and material properties.

For the sake of clarity, only those steps and elements that are useful for understanding the described embodiments have been shown and are described in detail. In particular, the various applications of fiber optic power supply systems have not been detailed, the described embodiments being compatible with all or most of usual applications likely to implement one or more fiber optic power supply systems, subject to possible adaptations within the abilities of those skilled in the art on reading the present disclosure.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

In the following description, the qualifiers “insulating” and “conductive” respectively mean, unless otherwise specified, electrically insulating and electrically conductive.

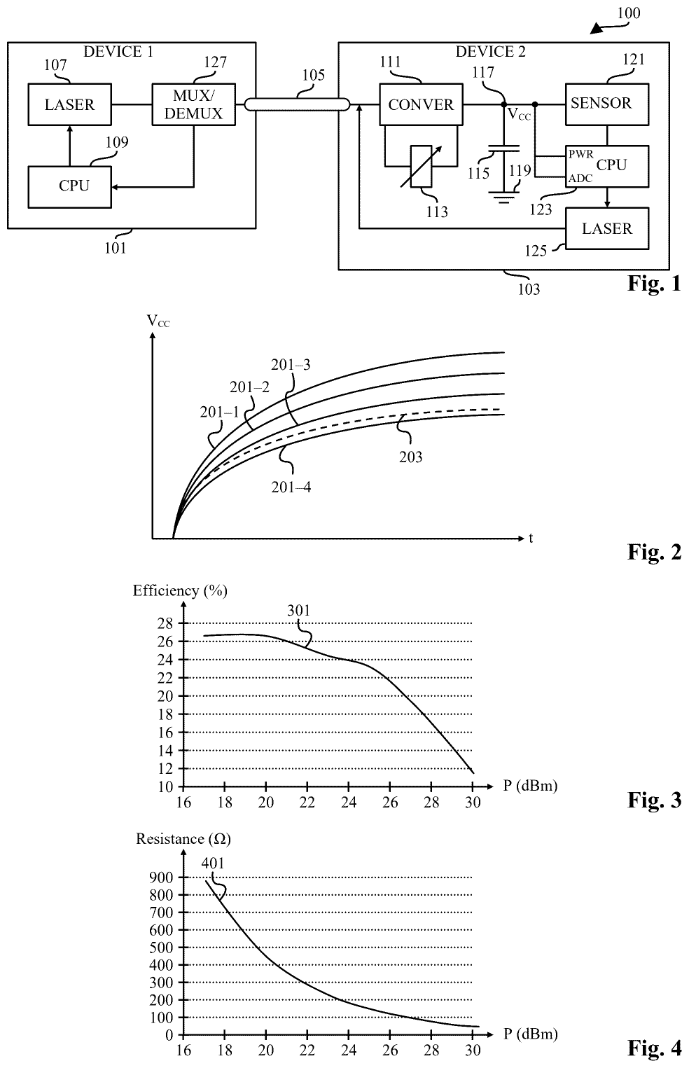

FIG. 1 schematically and partially illustrates, in the form of blocks, an example of a fiber optic power supply system 100 according to an embodiment.

In the shown example, system 100 comprises a first electronic device 101 (DEVICE 1) coupled to a second electronic device 103 (DEVICE 2) by an optical fiber 105. Device 101 is intended to deliver an optical signal for powering device 103, and optical fiber 105 enables to transmit the optical signal from device 101 to device 103.

Devices 101 and 103 are not, in the shown example, coupled by any link other than optical fiber 105. In particular, system 100 comprises no electrical link, for example a wired link comprising one or more conductive wires, between devices 101 and 103. The use of an optical link rather than of an electrical link to power device 103 from device 101, for example, enables to space apart devices 101 and 103 by several hundred meters or even several kilometers. In this case, the power supply of device 103 via an electrical link would result in energy losses, in particular a voltage drop, far greater than those caused by optical fiber 105. Further, the use of optical fiber 105 to couple devices 101 and 103 enables to do without the presence of a link transmitting an electrical power supply signal likely to disturb, or to be disturbed by, the environment of devices 101 and 103, for example in aeronautics or automobile related applications, etc.

In the illustrated example, device 101 comprises a laser source 107 (LASER) intended to generate the optical signal for powering device 103. Laser source 107 is more particularly intended to illuminate a first end of optical fiber 105, in the case in point the end via which optical fiber 105 is connected to device 101. Laser source 107 generates, for example, light rays corresponding to the optical signal for powering device 103.

In the shown example, device 101 further comprises a control chip 109 (CPU) connected to laser source 107. Control chip 109 is for example intended to control laser source 107. As an example, control chip 109 enables in particular to activate or to interrupt the transmission of the optical signal for powering device 103 by laser source 107, for example as a function of a state of a control signal transmitted by control chip 109 and received by laser source 107. As an example, control chip 109 is a microcontroller or a microprocessor.

In the illustrated example, device 103 comprises a photoelectric converter 111 (CONVER), for example a photovoltaic converter, intended to receive the optical power supply signal generated by device 101. Photoelectric converter 111 is more particularly intended to be illuminated from a second end of optical fiber 105 opposite to its first end, in the case in point, the end by which optical fiber 105 is connected to device 103. Photoelectric converter 111 for example enables to convert the optical signal generated by laser source 107 into an electrical signal for powering one or more components and/or circuits of device 103. As an example, photoelectric converter 111 is a photosensitive diode, also known as a photodiode.

In the illustrated example, device 103 further comprises a resistive component 113, for example a resistor, associated in parallel with photoelectric converter 111. Resistive component 113 has, for example, a variable resistance enabling to adjust an electrical impedance of photoelectric converter 111. This example is however not limiting and device 103 may, as a variant, comprise no resistive component 113.

In the shown example, device 103 further comprises a capacitive element 115 for storing electrical energy generated by photoelectric converter 111 when the latter is illuminated from the laser source 107 of device 101. As an example, capacitive element 115 is a capacitor, capacitive element 115 then comprising two conductive plates separated by an insulating region. In the illustrated example, the capacitive element 115 has one terminal, or electrode, connected to a node 117 of device 103 and another terminal, or electrode, connected to a node 119 for application of a reference potential, for example the ground. The terminals or electrodes of capacitive component 115 are, for example, respectively connected to its conductive plates. In the shown example, node 117 is connected to an output terminal of photoelectric converter 111. When laser source 107 is in operation, the optical signal for powering device 103 transmitted by optical fiber 105 illuminates photoelectric converter 111, thus causing an accumulation, across capacitive element 115, of charges photogenerated by photoelectric converter 111.

In the illustrated example, device 103 further comprises a sensor 121 (SENSOR) connected to node 117. Sensor 121 is for example intended to generate at least one measurement signal, for example an electrical voltage or current signal, representative of at least one physical quantity, for example selected from among: a temperature, a pressure, a flow rate, a distance, a weight, etc. Sensor 121 is, for example, electrically powered by capacitive element 115 and/or directly by photoelectric converter 111.

In the shown example, device 103 further comprises a control chip 123 (CPU), also known as a processing chip, connected to sensor 121. Control chip 123 is for example intended to receive and process the measurement signal generated by sensor 121. Control chip 123 is for example further connected to node 117. Similarly to sensor 121, control chip 123 is for example electrically powered by capacitive element 115 and/or directly by photoelectric converter 111. In the example shown in FIG. 1, control chip 123 comprises two terminals connected to node 117, in the case in point a power supply terminal PWR intended to receive a potential VDC present at node 117 and a digitizing terminal ADC coupled or connected to an analog/digital converter (not detailed in FIG. 1) of control chip 123. The analog/digital converter is, for example, adapted to acquiring and storing, for example in a memory of control chip 123, data representative of variations of the potential VCC present at node 117, and thus of a voltage present across capacitive element 115. As an example, the control chip 123 of device 103 is a microcontroller or a microprocessor.

In the illustrated example, device 103 further comprises a laser source 125 (LASER) connected to control chip 123. Laser source 125 is intended, for example, to transmit an optical data signal transmitted, by optical fiber 105, to device 101. In this example, laser source 125 is more particularly intended to illuminate the second end of optical fiber 105, that is, the end of optical fiber 105 opposite to that which is illuminated by the laser source 107 of device 101. Laser source 125 is, for example, similar to laser source 107, but differs from source 107 in that it has a different emission wavelength range and a lower optical power, or luminous flux. Unlike the optical power supply signal generated by laser source 107, the optical data signal generated by laser source 125 is not intended to allow the powering of electronic components or circuits after photoelectric conversion.

In the shown example, device 101 further comprises a multiplexer/demultiplexer 127 (MUX/DEMUX). Multiplexer/demultiplexer 127 is used, for example, to separate the optical data signal transmitted by laser source 125 and the optical power supply signal transmitted by laser source 107. In the shown example, multiplexer/demultiplexer 127 is interposed between laser source 107 and optical fiber 105 and optically couples laser source 107 to the first end of optical fiber 105. In this example, multiplexer/demultiplexer 127 is connected, via an optical link, to control chip 109. The optical link for example enables to transmit the data signal from device 103 to the control chip 109 of device 101.

As an example, control chips 109 and 123 and laser source 125 form part of a circuit for controlling devices 101 and 103 connected to capacitive element 115.

In operation, laser source 107 is for example activated so as to emit the optical signal for powering device 103. This optical signal is then transmitted by optical fiber 105 from device 101 to device 103 and converted, by photoelectric converter 111, into an electrical signal for powering device 103. This tends to charge capacitive element 115, and thus to increase the potential VCC present at node 117. The electrical energy generated by photoelectric converter 111 and/or the electrical energy stored by capacitive element 115 is, for example consumed, at least partially, by sensor 121, control chip 123, and/or laser source 125. Once powered, sensor 121 for example transmits to control chip 123 the electrical measurement signal. The latter is then converted into an optical measurement signal transmitted by laser source 125. The optical measurement signal is then transmitted by optical fiber 105 from device 103 to device 101. The optical measurement signal is then isolated, by multiplexer/demultiplexer 127, and then transmitted to control chip 109. This enables the control chip 109 of device 101 to acquire measurements of one or more physical quantities by means of sensor 121 without using an electrical link to couple device 101 to device 103.

The transmission of the optical power supply signal and of the optical measurement signal by optical fiber 105 is for example performed simultaneously. As a variant, the emission of the optical power supply signal by the laser source 107 of device 101 can be interrupted on emission of the optical measurement signal by the laser source 125 of device 103. As an example, the interruption of the emission of the optical supply signal by laser source 107 is requested by control chip 123, for example by means of a specific optical data signal comprising an interruption control signal. The control signal is then for example received and processed by control chip 109, which then interrupts the emission of radiation by laser source 107 for a time period enabling the optical measurement signal to be transmitted by optical fiber 105.

FIG. 2 is a graph showing simplified examples of charge curves of the capacitive element 115 of the device 103 of the fiber optic power supply system 100 of FIG. 1.

The graph of FIG. 2 more specifically illustrates examples of curves 201 (201-1, 201-2, 201-3, and 201-4) of variation, as a function of time t, of the potential VCC present at node 115. Curves 201 correspond, for example, to charge curves of capacitive element 115 for different optical powers P of laser source 107 (four different optical powers, in the example shown in FIG. 2). As an example, curves 201 form reference curves representative of cases in which system 100 has an optimal operation. Curves 201 are for example plotted at the end of a method of calibration of system 100. As a variant or as a complement, curves 201 may be plotted by means of calculation and/or numerical simulation tools.

Curves 201 for example more specifically form an abacus representative of the optimum operation of system 100. The reference charge curves 201 are for example stored in a memory of control chip 107 or in a memory of control chip 123. As an example, each curve 201 is stored in the form of a table of values. This example is however not limiting, and each curve 201 may, as a variant, be stored in the form of a mathematical equation.

According to an embodiment, the circuit for controlling the devices 101 and 103 of system 100 is configured to implement the following successive steps:
a) acquiring a charge curve 203 (dotted line) of capacitive element 115;
b) comparing charge curve 203 with one of the reference charge curves 201, for example reference charge curve 201-3; and
c) in case of a difference between charge curve 203 and reference charge curve 201 (curve 201-3, in this example), adapting a power of laser source 107.

Step a) of acquisition of the charge curve 203 of capacitive element 115 is for example implemented by control chip 123. Successive measurements of the potential VCC present at node 117 are for example performed by the input coupled or connected to the analog/digital converter of control chip 123 at different times, for example separated by an equal duration. The measurements of potential VCC are stored, for example, in a memory of control chip 123.

Step b) of comparison of charge curve 203 with the reference charge curve 201 is implemented, for example, by the control chip 109 of device 101. In this case, the charge curve 203 acquired by control chip 123 at step a) is transmitted, via the laser source 125 of device 103 and optical fiber 105, to control chip 109 for comparison with reference charge curve 201. Control chip 109 being used to control laser source 107, it knows, for example, the optical power transmitted by laser source 107, to be able to determine with which reference charge curve 201 to compare charge curve 203.

As a variant, step b) of comparison of charge curve 203 with reference charge curve 201 may be implemented by the control chip 123 of device 103. In this case, device 101 transmits for example to device 103, by means of optical fiber 105, data representative of the optical power transmitted by laser source 107, so that device 103 can determine with which reference charge curve 201 to compare charge curve 203. Another option may consist in sampling, at the output of optical fiber 105, a portion of the optical signal to estimate the optical power transmitted by laser source 107 and deduce therefrom with which reference load curve 201 to compare charge curve 203.

Step c) of detection of a difference between the charge curve 203 acquired at step a) and the reference charge curve 201 is for example implemented by the control chip having carried out step b). The detection of a difference between curves 203 and 201 indicates the presence of a fault or malfunction of system 100, for example, an overheating of photoelectric converter 111, resulting in a drop in efficiency appearing as a disturbance in the charge of capacitive element 115.

In the case where step b) has been implemented by the control chip 109 of device 101, and if a difference has been detected between curves 203 and 201, control chip 109 transmits to laser source 107 a control signal for adapting the optical power, for example a control signal for decreasing the optical power. In the case where step b) has been implemented by the control chip 123 of device 103 and if a difference has been detected between curves 203 and 201, the control signal for adapting the optical power is for example transmitted by control chip 123 in the form of an optical control signal emitted by laser source 125 and received by control chip 109, which then modulates the optical power of laser source 107. This for example enables to decrease or to limit the heating of photoelectric converter 111, thus improving its efficiency.

The above-mentioned steps a), b), and c) are for example implemented during a phase of power supply of device 103 by device 101. As an example, each power supply phase comprises an alternation of at least one phase of charge of capacitive element 115 followed by a phase of discharge of capacitive element 115. During the charge phase, laser source 107, for example, injects the optical power supply signal from device 103 into optical fiber 105, and laser source 125 is kept switched off. During the discharge phase, laser source 107 is for example kept off and laser source 125 is used to inject the optical data signal, comprising for example the optical measurement signal, into optical fiber 105. Charge curve 203 is acquired, for example, during the charge phase, the optical data signal transmitted during the discharge phase comprising, for example, data relative to charge curve 203, to enable control chip 109 to perform the comparison provided at step b), or directly a control signal to decrease the optical power of laser source 107. This for example enables control chip 109 to decrease the optical power of laser source 107 for the next charge phase.

The above-mentioned implementation of steps a), b), and c) amounts to using capacitive element 115 for storing the electrical energy generated by photoelectric converter 111 as a sensor enabling to detect a degradation or a malfunction of system 100. This has the advantage of avoiding the implementation of optical samplings and/or the use of filters.

FIG. 3 is a graph showing an example of a curve 301 of variation, as a function of the incident optical power P (in decibel-milliwatts, dBm), of a conversion efficiency (in percent, %) of the photoelectric converter 111 of the fiber optic power supply system 100 of FIG. 1.

In the shown example, the conversion efficiency of photoelectric converter 111 decreases as the incident optical power P increases.

FIG. 4 is a graph showing an example of a curve 401 of variation, as a function of the incident optical power P (in decibel-milliwatts, dBm), of a resistance (in ohms, (2) of resistive component 113 associated in parallel with the photoelectric converter 111 of the fiber optic power supply system 100 of FIG. 1.

In the shown example, the resistance of resistive component 113 decreases as the incident optical power P increases.

Each value of power P is associated with a resistance value of resistive component 113, enabling to obtain a maximum efficiency of photoelectric converter 111.

According to an embodiment, the control circuit of system 100 is, as a variant or as a complement, configured to implement the following successive steps:
d) determining a resistance value R of resistive component 113 for which photoelectric converter 111 has an optimum efficiency;
e) comparing resistance value R with a reference resistance value R_{ref}, and
f) in case of a difference between resistance value R and reference resistance value R_{ref}, adapting the power of laser source 107.

Step d) of determination of the resistance value R of resistive component 113 for which photoelectric converter 111 has an optimum efficiency is implemented, for example, by control chip 123. Successive measurements of a physical quantity which is an image of the efficiency of photoelectric converter 111, for example a current, or photocurrent, supplied by photoelectric converter 111 when it is illuminated from the second end of optical fiber 105, are for example performed by control chip 123, for different resistance values of resistive component 113, in order to estimate the resistance value R for which the maximum conversion efficiency is achieved. As an example, a range of resistance values centered on the reference resistance value R_{ref} corresponding to the considered optical power is scanned and the conversion efficiency is estimated for each resistance value. The efficiency estimates for each resistance value are stored, for example, in a memory of control chip 123 or in a memory of control chip 109.

Step e) of comparison of resistance R with reference resistance R_{Ref} is carried out, for example, by the control chip 109 of device 101. In this case, the resistance R determined by control chip 123 at step d) is transmitted, by the laser source 125 of device 103 and by optical fiber 105, to the control chip 109 for comparison with reference resistance R_{Ref}. Control chip 109 being used to control laser source 107, it knows, for example, the optical power transmitted by laser source 107, to be able to determine with which reference resistance R_{Ref} to compare resistance R.

As a variant, step e) of comparison of resistance R with reference resistance R_{Ref} can be implemented by the control chip 123 of device 103. In this case, device 101 transmits for example to device 103, by means of optical fiber 105, data representative of the optical power transmitted by laser source 107 so that device 103 can determine with which reference resistance R_{Ref} to compare resistance R. Another option may consist in sampling, at the output of optical fiber 105, a portion of the optical signal to estimate the optical power emitted by laser source 107 and to deduce therefrom with which reference resistance R_{Ref} to compare resistance R.

Step f) of detection of a difference between the resistance R determined at step d) and the reference resistance R_{Ref} is implemented, for example, by the control chip having carried out step b). The detection of a difference between resistances R and R_{Ref} indicates the presence of a fault or malfunction of system 100, for example, an overheating of photoelectric converter 111 causing a drop in efficiency resulting in a change in the optimum resistance value of resistive component 113.

In the case where step f) has been implemented by the control chip 109 of device 101, and if a difference between resistances R and R_{Ref} has been detected, control chip 109 transmits to laser source 107 a control signal for adapting the optical power, for example a control signal for decreasing the optical power. In the case where step f) has been implemented by the control chip 123 of device 103 and if a difference has been detected between resistors R and R_{Ref}, the control signal for adapting the optical power is for example transmitted by control chip 123 in the form of an optical control signal transmitted by laser source 125 and received by control chip 109, which then modulates the optical power of laser source 107. This for example enables to decrease or to limit the heating of photoelectric converter 111, and thus to improve its efficiency.

The above-mentioned steps d), e), and f) are implemented, for example, during each phase of power supply of device 103 by device 101.

Various embodiments and variants have been described. Those skilled in the art will understand that certain features of these various embodiments and variants may be combined, and other variants will occur to those skilled in the art. In particular, those skilled in the art are capable, based on the indications of the present disclosure, of taking advantage of the determination of the charge curves of the capacitive element 115 of device 103 and/or of the resistance values R of variable resistive element 113 enabling to obtain a maximum conversion efficiency of photoelectric converter 111 to modulate the optical power of laser source 107 in order to optimize the operation of system 100.

Finally, the practical implementation of the described embodiments and variants is within the abilities of those skilled in the art based on the functional indications given hereabove. In particular, the practical implementation of the various components and circuits of the devices 101 and 103 of system 100, in particular the implementation of the control circuit enabling to implement the steps leading to the optimization of the operation of system 100 based on charge curves of capacitive element 115 and/or of resistance values R of the variable resistive element 113 enabling to obtain a maximum conversion efficiency of photoelectric converter 111, is within the abilities of those skilled in the art based on the indications of the present disclosure.

1. System comprising first and second electronic devices coupled by an optical fiber, wherein:
the first electronic device comprises a laser source intended to illuminate a first end of the optical fiber;
the second electronic device comprises a photoelectric converter intended to be illuminated from a second end of the optical fiber opposite to the first end, and a capacitive element for storing electrical energy generated by the photoelectric converter; and
the first and second electronic devices comprise a control circuit connected to the capacitive element and configured to implement the following successive steps:
a) acquiring a first charge curve of the capacitive element;
b) comparing the first charge curve with a second reference charge curve; and
c) in case of a difference between the first and second charge curves, adapting an optical power of the laser source.

2. System according to claim 1, wherein step b) is implemented by a first control chip of the first electronic device.

3. System according to claim 1, wherein step b) is implemented by a second control chip of the second electronic device.

4. System according to claim 1, wherein the second electronic device further comprises a variable resistive component associated in parallel with the photoelectric converter, the control system being further configured to implement the following successive steps:
d) determining a first resistance value of the variable resistive component for which the photoelectric converter has an optimum conversion efficiency;
e) comparing the first resistance value with a second reference resistance value; and
f) in case of a difference between the first and second resistance values, adjusting the optical power of the laser source.

5. System according to claim 4, wherein step e) is implemented by a first control chip of the first electronic device.

6. System according to claim 4, wherein step e) is implemented by a second control chip of the second electronic device.

7. System according to claim 4, wherein the conversion efficiency is estimated by a measurement of a photocurrent supplied by the photoelectric converter.

8. System according to claim 1, wherein the adaptation of the power of the laser source is a decrease in the power of the laser source.

9. System according to claim 1, wherein the capacitive element is a capacitor comprising two conductive plates separated by an insulating region.

10. System according to claim 1, wherein the first and second devices are coupled by the optical fiber only.

11. Method of controlling a system comprising first and second electronic devices coupled by an optical fiber, wherein:
the first electronic device comprises a laser source intended to illuminate a first end of the optical fiber;
the second electronic device comprises a photoelectric converter intended to be illuminated from a second end of the optical fiber opposite to the first end and a capacitive element for storing electrical energy generated by the photoelectric converter; and
the first and second electronic devices comprise a control circuit connected to the capacitive element,
the method comprising the following successive steps, implemented by the control circuit:
a) acquiring a first charge curve of the capacitive element;
b) comparing the first charge curve with a second reference charge curve; and
c) in case of a difference between the first and second charge curves, adapting an optical power of the laser source.

12. Method according to claim 11, further comprising the following successive steps, implemented by the control circuit:
d) determining a first resistance value of a variable resistive component of the second electronic device, associated in parallel with the photoelectric converter, for which the photoelectric converter has an optimum conversion efficiency;
e) comparing the first resistance value with a second reference resistance value; and
f) in case of a difference between the first and second resistance values, adjusting the optical power of the laser source.
